(19) United States
(12) Patent Application Publication
(10) Pub. No.: US 2014/0218778 A1
(43) Pub. Date: Aug. 7, 2014

(54) Hologram

(71) Applicant: THE SECRETARY OF STATE FOR BUSINESS, INNOVATION & SKILL OF HER MAJESTY'S BRITANNIC GOVERNMENT, London (GB)

(72) Inventors: Simon Richard Geoffrey Hall, London (GB); Richard Frederick Stevens, London (GB)

(73) Assignee: THE SECRETARY OF STATE FOR BUSINESS, INNOVATION & SKILLS OF HER MAJESTY'S BRITANNIC GOVERNMENT, London (GB)

(21) Appl. No.: 14/241,785

(22) PCT Filed: Aug. 31, 2012
(86) PCT No.: PCT/GB2012/052138

§ 371 Date: Apr. 21, 2014

(30) Foreign Application Priority Data
Sep. 2, 2011 (GB) 1115208.9

(51) Int. Cl. G03H 1/04; G03H 1/22; G03H 1/02

(52) U.S. Cl. CPC G03H 1/0465; G03H 1/0272; G03H 1/2286; G03H 2001/0268; G03H 2001/0473
USPC 359/3; 359/32; 359/27; 359/1

(57) ABSTRACT

A substrate includes a diffracting structure providing a hologram (20, 6). The diffracting structure encodes a holographic image so that thatholographic image is produced in response to reference light being incident on a major surface of the substrate at an angle of incidence with respect to the said major surface of the substrate, wherein the angle of incidence is no more than 20°.

The present invention relates to holograms.

A holographic image is formed by illuminating a hologram with a reference beam. The source of the reference beam is placed at a sufficient distance to ensure the hologram is fully illuminated. Current techniques used to reconstruct holographic images employ light sources and illumination systems that are relatively bulky.

Known hologram systems are described for example in Saxby G. Practical Holography. Institute of Physics Publishing, Philadelphia 2004, and Ludman J et al, Editors, Holography for the New Millennium, Springer New York, 2002

Current systems are limited in the degree of compactness obtainable. Conventional hologram illumination requires the light source to be placed at a significant distance from the hologram plate. This makes the hologram display bulky.

Prior art systems also generally avoid high angles of illumination beyond 71° to the normal. This is because the angle of illumination, the angle of the object beam in the recording medium and the light coupled into the hologram are limited by the refractive indices of the recording medium and the substrate. The light lost at such large angles to the normal can be disadvantageous.

Optical aberrations in compact optical systems can also be a limitation.

Other techniques include total internal reflection (TIR) holograms and edge-illuminated holograms. Typical of the problems encountered are “wood-grain” effects due to multiple reflections within the substrate.

Regarding the wood grain effect, Fresnel reflections in edge-lit holograms are discussed by Metz in chapter 3 of “Holography for the New Millennium” referred to above.

With edge-illuminated holograms, light enters the hologram substrate through a polished edge. Light is transmitted within the substrate and encounters the substrate/air and substrate/hologram boundaries at grazing angles. Spurious reflections may be created at these boundaries and can interfere and create a pattern resembling that of wood-grain. This is inefficient and distracting to the viewer.

The present invention seeks to provide an improved hologram, hologram arrangement and method of manufacturing a hologram.

According to an aspect of the invention, there is provided a substrate including a diffracting structure providing a hologram, the diffracting structure encoding a holographic image so that the holographic image is produced in response to reference light being incident on a major surface of the substrate at an angle of incidence with respect to the said major surface of the substrate, wherein the angle of incidence is no more than 20°.

Holograms are used to generate images in space. Embodiments of this invention allow such images to be illuminated in a very compact arrangement.

Preferred embodiments of the invention provide a substrate which can produce a holographic image when illuminated by a reference light at very shallow angles. This can mean that a source of reference light can be placed in close proximity to the substrate (also referred to as the hologram plate), allowing a hologram arrangement to be produced which is compact. It allows a hologram illumination package to be contained within a compact envelope and does not require the large arrangements common in the prior art.

Replaying (i.e. illuminating the substrate with reference light to enable the holographic image to be viewed) with reference light with the same wavelength, geometry and optics as was used in recording the hologram allows aberrations of the optical system to be cancelled.

Preferably the angle of incidence is no more than 15°, preferably at least 5° and most preferably substantially 10° or between 8.5° and 10°. The useful zone where light loss is not drastic (50%) and where interface artefacts are manageable is between 80 and 81.5 degrees to the normal to the substrate.

Preferably the said major surface of the substrate forms an interface between the substrate and a vacuum or a fluid such as air. This can provide for a much less complex arrangement than prior art edge-lit holograms.

Preferred embodiments are able to reproduce holographic images of objects at greater distances from the substrate than many prior art edge-lit holograms.

Throughout this description references to high or large angles refer to the angle with respect to the normal of the substrate and references to low or shallow angles refer to the angle with respect to the surface of the substrate.

Preferably, the diffracting structure of the substrate provides a transmission hologram, wherein the said major surface of the substrate is a rear surface.

In some embodiments, the substrate comprises silver halide, preferably with a grain size of no more than 20 nm. Silver halide material is much more sensitive than photopolymer material and is thus much more practical for this application in which a lot of light is lost coupling into the recording material at the recording stage. A small grain size is preferable to ensure a high resolution and reduced scatter.

Much of the prior art excludes silver halide because of refractive index problems. Refractive index differences between the substrate and the emulsion can cause light loss and stray reflections.

Preferred embodiments use very high resolution silver halide material with small grain size. This has enabled the recording and replay with a simple diverging spherical wavefront at high angles of incidence. Unlike the use of illumination through the edge of a substrate, the replay conditions can be precisely matched to the recording conditions, and very large depths achieved in the reconstructed image.

In some embodiments, the substrate comprises photopolymer.

According to an aspect of the invention, there is provided a hologram arrangement including a substrate as described above and a reference light source, wherein the reference light source is arranged to emit reference light to be incident on the said major surface of the substrate at the said angle of incidence.

The lowest light loss configuration for illumination or replay of the holographic image would be with P polarised reference light. This polarisation is more readily coupled into the hologram and substrate and is preferable for efficient replay. S polarisation is more useful in recording to minimise unwanted effects due to internal reflections.

Preferably, the reference light source is a source of coherent or substantially coherent light, such as a laser source or an LED. Coherence depth relates to the depth of the hologram so for example LEDs can be used but would only allow a shallow depth of hologram. In a preferred embodiment, the reference light source is a laser diode which is configured to emit a light beam the divergence of which is greater in one of two mutually transverse planes than the other, wherein both of the two mutually transverse planes include and are therefore parallel to the direction of propagation of the light beam. The reference light source is arranged to emit the light beam with the plane of greater divergence being substantially parallel to the said major surface of the substrate. This can allow the reference light source to be placed in close proximity to the substrate, since the beam will diverge in a plane substantially parallel to the substrate more rapidly than the beam will diverge towards the substrate. Therefore, by the time the beam is incident on the substrate, it will have spread in a direction which is transverse to the direction of propagation of the beam and parallel to the said major surface of the substrate, meaning that the beam is able to light a greater area of the said major surface of the substrate than would be possible for a beam which either had less divergence or which diverged a similar amount in all directions perpendicular to the direction of propagation.

Proximity of the reference light source to the substrate is better for compactness but enough path length is preferably provided so the beam diverges enough to allow coverage of the hologram plate.

In general lasers are not very compact. Embodiments of this invention use laser diodes making for a more compact device.

In some embodiments, the arrangement includes a reflective surface, such as a mirror, arranged to reflect the reference light from the reference light source to the said major surface of the substrate. In some embodiments, the reflective surface is arranged to cause the reference light to diverge more in one of two mutually transverse planes than the other, wherein both of the two mutually transverse planes include and are therefore parallel to the direction of propagation of the reference light in a similar manner to that described above. In some embodiments, the arrangement includes the reflective surface but not the reference light source.

In some embodiments, the diffracting structure has a length and a width perpendicular to the length, the length being perpendicular to a direction of propagation of reference light incident at the said angle of incidence, wherein the arrangement is configured to cause reference light from the reference light source to diverge in a direction parallel to the length of the diffracting structure so as to illuminate at least the entire length of the diffracting structure. Preferably the arrangement is configured to cause the reference light to diverge in a direction perpendicular to the length of the diffracting structure so as to illuminate at least the entire width of the diffracting structure. In some embodiments, the divergence is caused by an optical element such as a lens or a reflective surface. In some embodiments, the divergence is caused by the selection of the reference light source, for example or a laser diode.

Preferably, the diffracting structure of the substrate provides a transmission hologram, wherein the said major surface of the substrate is a rear surface, and the arrangement includes a light absorbent backdrop to the rear of the substrate. This can absorb unwanted reflections and scatter from the substrate, allowing the production of a clearer holographic image.

According to an aspect of the invention, there is provided a method of manufacturing a substrate as described above. This can be achieved by recording the hologram with a reference light beam at a large (high) angle of incidence to the normal to a light sensitive medium.

According to an aspect of the invention there is provided a method of manufacturing a hologram, including:

illuminating an object with a first light beam so that light scattered from the object passes to a light sensitive medium;

illuminating the light sensitive medium with a second light beam which is coherent with the first light beam, wherein the second light beam is incident on the light sensitive medium at an angle to the normal of the light sensitive medium of at least 70°; and subsequently manufacturing a hologram derived from the light sensitive medium.

In some embodiments for recording the hologram a light sensitive medium can be placed in a rig and illuminated with reference light, the reference light being a normal circular beam from a fibre, the fibre being also fixed to the rig. A hologram can then be produced from the light sensitive medium. For replay, the hologram can be placed in an identical rig but with an LED where the fibre was previously located.

Preferred embodiments of the invention are described below, by way of example only, with reference to the accompanying drawings, in which

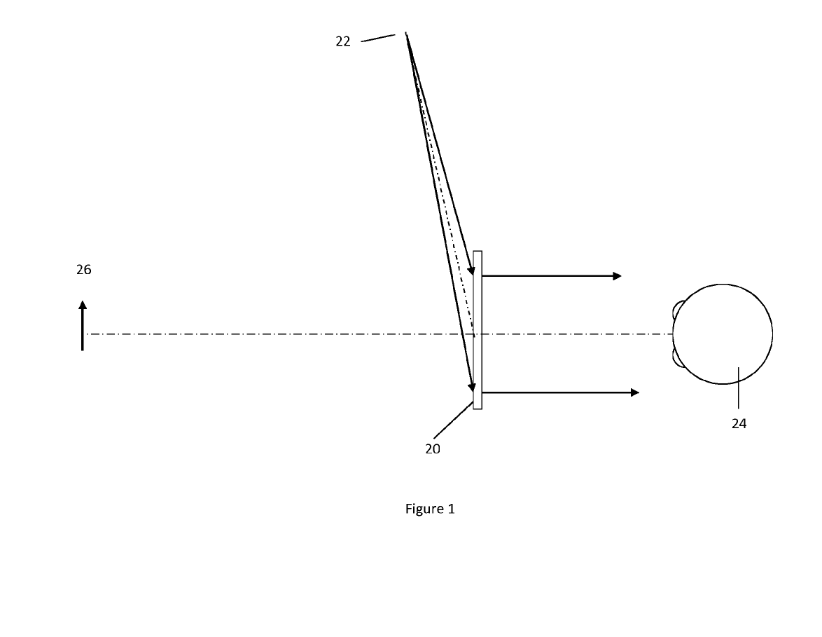

FIG. 1 is a schematic diagram of a hologram arrangement producing a holographic image in transmission;

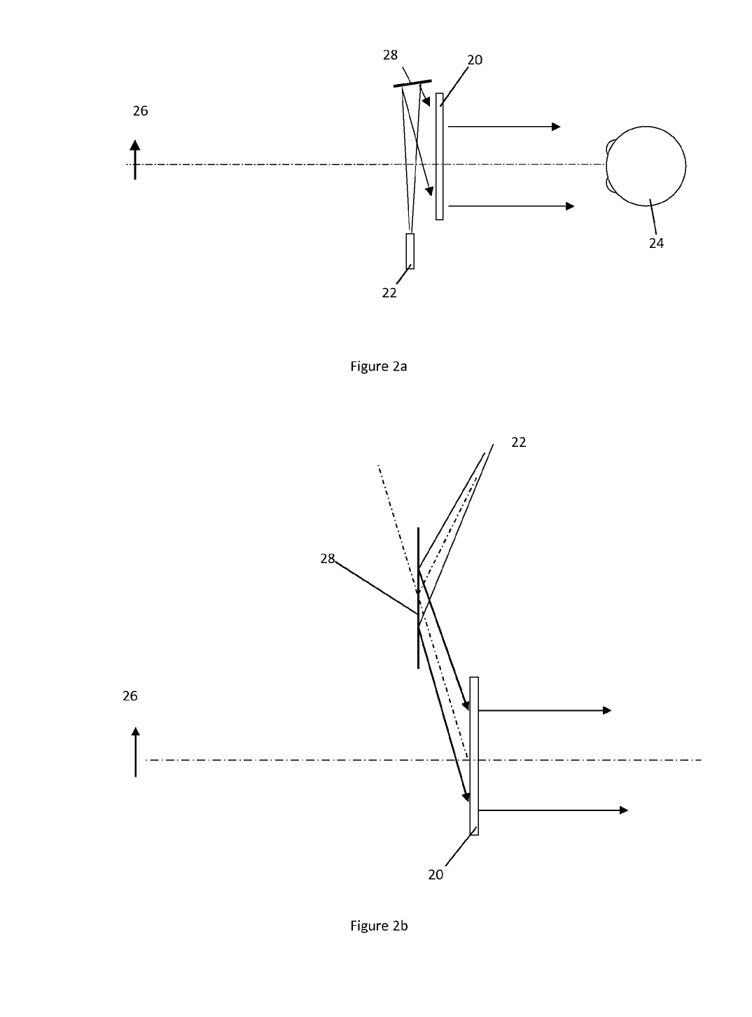

FIGS. 2a and 2b are schematic diagrams of a hologram arrangement producing a holographic image in which an illumination beam path is folded with a mirror;

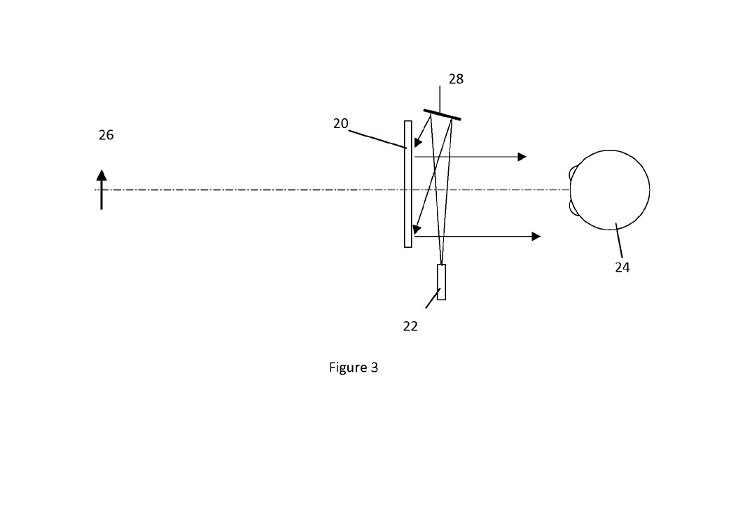

FIG. 3 is a schematic diagram of a hologram arrangement producing a holographic image by reflection;

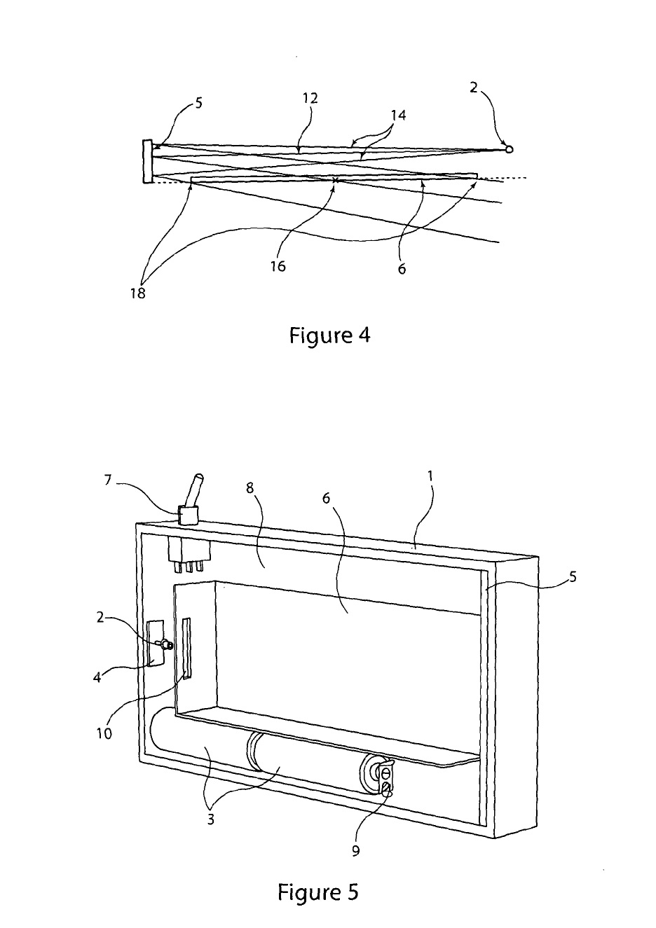

FIG. 4 is a schematic plan view of a hologram arrangement showing the rays during use;

FIG. 5 is a perspective view of the hologram arrangement of FIG. 4;

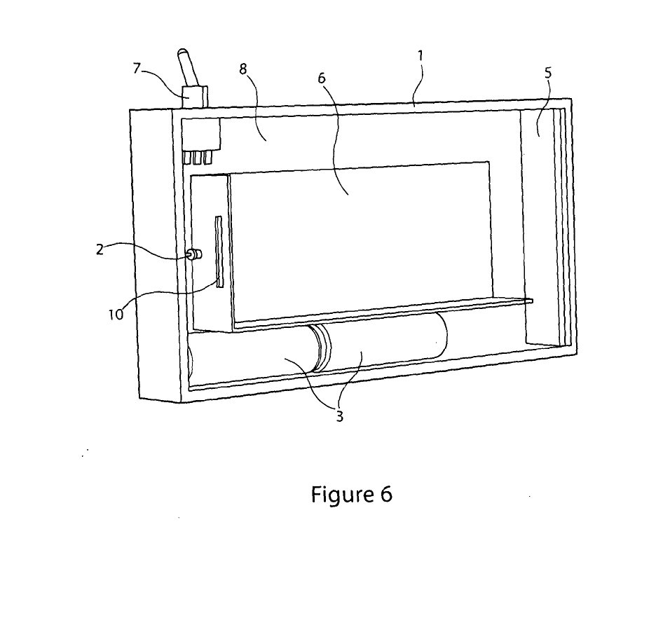

FIG. 6 is an alternative perspective view of the hologram arrangement of FIGS. 4 and 5;

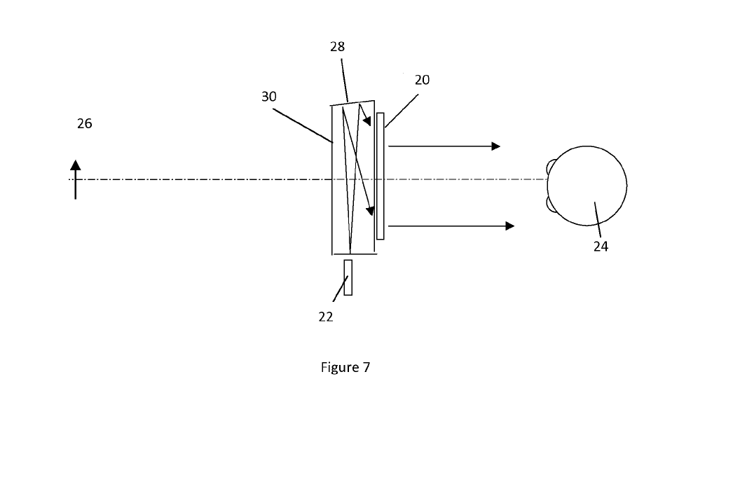

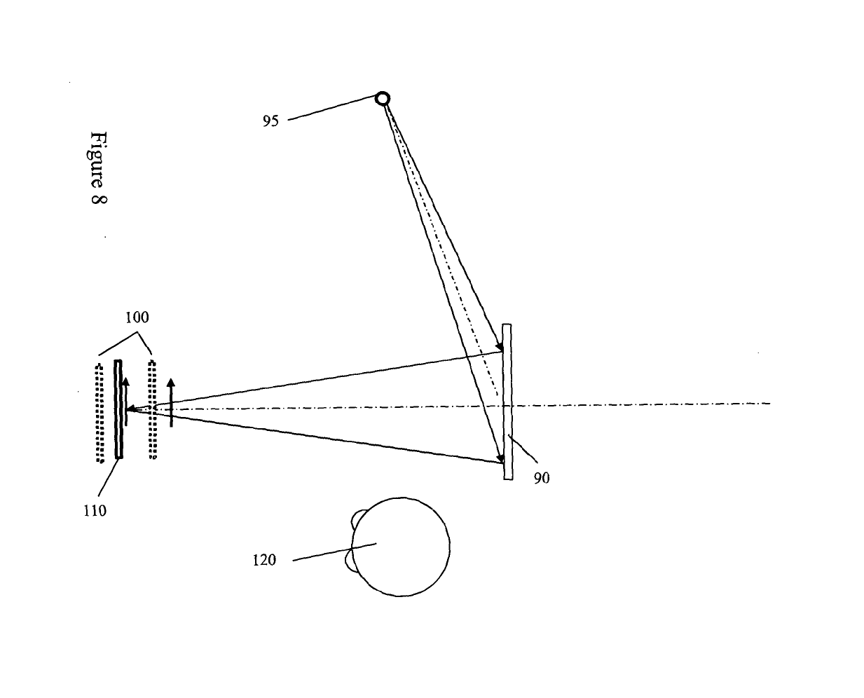

FIG. 7 is a schematic diagram of a hologram arrangement producing a holographic image by illuminating a substrate via a thick cover glass; and

FIG. 8 is a schematic diagram of a hologram arrangement producing a plurality of images at different depths.

### RECORDING THE HOLOGRAM

A hologram is fabricated by recording in a light sensitive medium the interference pattern generated by two coherent wavefronts, one arising from the object and the other from a reference source. The light sensitive medium is usually supported by a transparent substrate made from a material such as glass, silica or plastic.

In one embodiment the light sensitive medium may be a photopolymer layer. It is thought that the refractive index of this material is modified by the illumination during the recording process, increasing the efficiency of coupling into the photopolymer layer.

In another embodiment the light sensitive medium may be silver halide in gelatin material. The problem of shrinkage after wet-processing of silver halide materials is well known. Shrinkage usually changes the optical conditions for replaying the hologram, increasing the difficulty with which efficient high incidence angle holograms can be made.

Electronic recording is possible and thin digital holographic cameras are being developed. (Ref. Hahn J et al, Applied Optics vol 50 (24) pp 4848-4854, 2011)

There have previously been various problems with holograms illuminated at a high angle to the normal, but many disappear when lasers are used to replay. For example the greater dispersion at higher angles i.e. increased chromatic dispersion which produces chromatic blur thus necessitates narrower linewidth illumination sources.

Illumination Geometries

Embodiments of the present invention enable the device to be made compact. To record the hologram the light from the reference source is incident at the recording medium at a large angle (greater than 70°) to the normal. The recording is processed to yield a substrate including a diffracting structure providing a hologram 20 that when illuminated under specific conditions such as from a reference light source 22 redirects light to an observer 24 who sees a reconstructed holographic image 26 (FIG. 1). It will be appreciated that in all embodiments shown in the Figures light from the reference source is incident at the hologram plate or substrate an angle of at least 70° to the normal.

In one embodiment the light path is direct and the source 22 of the illuminating beam is placed at a small distance from the hologram to produce a compact device (FIG. 1).

In another embodiment of the invention the path of the illuminating beam is folded using a plane mirror 28. The mirror may be positioned nearly normal to the hologram substrate or nominally parallel to the substrate (FIGS. 2a,2b respectively).

In another embodiment the hologram 20 is illuminated from the front. A mirror 28 is used to fold the beam path and illuminate the hologram 20 at a large angle of incidence (FIG. 3).

Hologram Arrangement

A specific embodiment of a compact self-contained unit within which a hologram is illuminated at a grazing angle is described below with particular reference to FIGS. 4 to 6.

The unit includes a box (1) where the depth is 2 cm. Within the box is a laser diode (2) powered in this instance by batteries (3) held in a battery holding unit (9). In other embodiments the unit is powered by rechargeable batteries, or a power supply, or a USB from a computer.

The diode 2 is driven by a PCB (4) with the relevant electronics. The diode beam points directly at a mirror (5) located on the opposite side of the unit which relays the beam to a substrate including a diffracting structure providing a hologram (6) at a grazing angle of less than 20° to a rear major surface of the substrate. In this example the beam enters the hologram at 8.5 degrees as measured from the corresponding position of the mirror to the centre of the hologram.

In this example the beam is elliptical with the long axis of the beam coinciding with the short dimension or vertical view of the hologram. The beam emerges heavily elliptical due to the slit like dimensions of the LED material. The short axis of the beam is sufficient to illuminate the whole length of the plate at the grazing angles used (in this embodiment 0.75 inch or 20 mm is enough for the short axis of the beam at the point where the beam enters the hologram).

However, the vertical extent of the plate is 2″ or 50 mm and the beam must cover that (in its long axis) at the start point where it first hits the hologram plate.

In this unit there is no need for lenses with this particular configuration as this is the diode's unmodified output. The beam is elliptical due to the solid state laser properties. A slit (10) that matches this beam profile isolates the laser diode from the hologram by excluding extraneous light. The unit has a toggle switch (7) for turning power on or off.

FIG. 4 shows the paths during use of a central ray 12 and marginal rays 14 from the laser diode 2, with respect to the hologram centre 16, hologram edges 18, and a first surface of the mirror 5.

The view of the holographic image is enhanced by utilising a light absorbing black material (8) inside the housing which prevents stray light or spurious artefacts from being seen behind the hologram which would otherwise interfere with the clear view of the holographic image.

The unit could also be equipped with timing circuits which can warn the user at specified intervals to look at the hologram. The timing circuits would then turn on the laser diode to illuminate the display and produce the holographic image.

In another embodiment of the invention the hologram 20 plane is one face of a thick cover glass or prism 30 and the beam-folding mirror 28 is an end face of the same thick cover glass 30. This provides for a monolithic construction with stable geometry (FIG. 7).

FIG. 7 is shows a rugged version of FIG. 2a and the optical alignment is more readily maintained. The optical block 30 supports the hologram 20 and also incorporates the mirror 28 surface.

In another embodiment of the invention the path of the illuminating beam is folded using a spherical mirror. The spherical mirror has optical power which contributes to the expansion of the reference beam, enabling a more compact space to be used.

In some embodiments the holographic image may include image elements to be reconstructed at one or more predefined finite distances from the hologram substrate. In other embodiments the holographic image may include image elements to be reconstructed at infinity.

In another application shown in FIG. 8, use may be made of real optical images generated by a hologram 90 which is illuminated by a reference light source 95. Real images 100 may be projected onto a moveable screen 110 or surface and in one application a depth gauge allows for a viewer 120 to measure or estimate the distance to or determine the presence of real objects by determining which of the holographic real images coincides with the object under test using focusing cues.

In one embodiment the hologram 90 generates a two dimensional image of a fiducial mark such as a crossline target. In another embodiment the hologram 90 generates a series of two dimensional images 100 at different distances. In another embodiment the hologram 90 generates a continuous three-dimensional image 100 of grid lines to enable a continuous three-dimensional surface to be verified.

For example, this can be applied to the measurement of car body panels(large scale) or microscopic measurements of cells(small scale).

Applications of Embodiments of the Invention

Compact ophthalmic fixation target to enable the use of diagnostic and therapeutic instruments.

Advertising

Gaming

Head-up displays

Visual acuity testing

Stereoscopic acuity using holograms at different depths

For fitting eyeglasses so that the lenses are centred in the visual axis. Can be used in conjunction with a pupil spacing measurement system for better assurance in fitting spectacle frames for progressive lenses, and other speciality lenses, since small errors cause eyestrain in certain prescriptions.

Eyestrain relief for visual display units or microscopy

Advantages

Embodiments of the invention provide a simple lightweight optical device that achieves the effect of generating an image without the need for a heavy, complicated and bulky optical system. This facilitates use for practical wearable displays.

For example, this means that infinity accommodation of human eyes can be achieved in a small space (without an 8 m optical path).

The hologram may be replicated at low cost for mass production.

Features and modifications of embodiments of the invention can be combined and/or interchanged as desired.

The disclosures in British patent application no. GB 1115208.9, from which this application claims priority, and in the abstract accompanying this application, are incorporated herein by reference.

1. A substrate including a diffracting structure providing a hologram, the diffracting structure encoding a holographic image so that the holographic image is produced in response to reference light being incident on a major surface of the substrate at an angle of incidence with respect to the said major surface of the substrate, wherein the angle of incidence is no more than 20°.

2. A substrate according to claim 1, wherein the angle of incidence is no more than 15°, preferably at least 5° and most preferably substantially 10° or between 8.5° and 10°.

3. A substrate according to claim 1, wherein the holographic image is produced in response to reference light being incident on an exterior face of the major surface of the substrate at the angle of incidence with respect to the said major surface of the substrate.

4. A substrate according to claim 1, wherein the said major surface of the substrate forms an interface between the substrate and a vacuum or a fluid.

5. A substrate according to claim 4, wherein the fluid is air.

6. A substrate according to any preceding claim 1, wherein the diffracting structure of the substrate provides a transmission hologram.

7. A substrate according to claim 1, comprising silver halide.

8. A substrate according to claim 7, wherein a grain size of the silver halide is no more than 20 nm.

9. A hologram arrangement including a substrate and a reference light source; wherein the substrate includes a diffracting structure providing a hologram, the diffracting structure encoding a holographic image so that the holographic image is produced in response to reference light being incident on a major surface of the substrate at an angle of incidence with respect to the said major surface of the substrate, wherein the angle of incidence is no more than 20°; wherein the reference light source is arranged to emit reference light to be incident on the said major surface of the substrate at the said angle of incidence.

10. A hologram arrangement according to claim 9, wherein the light source is configured to emit reference light with P polarisation.

11. A hologram arrangement according to claim 9, wherein the reference light source is a source of coherent or substantially coherent light, preferably a laser diode.

12. A hologram arrangement according to claim 9, including a reflective surface arranged to reflect the reference light from the reference light source to the said major surface of the substrate.

13. A hologram arrangement according to claim 9, wherein the diffracting structure has a length and a width perpendicular to the length, the length being perpendicular to a direction of propagation of reference light incident at the said angle of incidence, wherein the arrangement is configured to cause reference light from the reference light source to diverge in a direction parallel to the length of the diffracting structure so as to illuminate at least the entire length of the diffracting structure.

14. A method of manufacturing a hologram, including:
illuminating an object with a first light beam so that light scattered from the object passes to a light sensitive medium;
illuminating the light sensitive medium with a second light beam, wherein the second light beam is coherent with the first light beam, wherein the second light beam is incident on the light sensitive medium at an angle to the normal of the light sensitive medium of at least 70°; and subsequently manufacturing a hologram derived from the light sensitive medium.

15. A method according to claim 14, wherein manufacturing the hologram comprises manufacturing a substrate including a diffracting structure providing a hologram, the diffracting structure encoding a holographic image so that the holographic image is produced in response to reference light being incident on a major surface of the substrate at an angle of incidence with respect to the said major surface of the substrate, wherein the angle of incidence is no more than 20°.
